(19) United States
(12) Patent Application Publication
(10) Pub. No.: US 2026/0225242 A1
(43) Pub. Date: Aug. 6, 2026

(54) SUCTION AND EDGE GRASPING COMBINATION GRIPPER

(71) Applicant: Dexterity, Inc., Redwood City, CA (US)

(72) Inventors: Samir Menon, Atherton, CA (US); Julia Wettersten, Redwood City, CA (US); Andrew Lovett, San Mateo, CA (US)

(21) Appl. No.: 19/452,080

(22) Filed: Jan. 16, 2026

Related U.S. Application Data
(60) Provisional application No. 63/746,776, filed on Jan. 17, 2025.

(51) Int. Cl. B25J 9/16; B25J 15/06

(52) U.S. Cl. CPC B25J 9/1661; B25J 15/0616

(57) ABSTRACT

A suction and edge or other grasping combination gripper is disclosed. In various embodiments, the combination gripper is configured to be mounted on a robotic arm and includes a first set of elements configured to grasp an item by applying suction to a surface of the item and a second set of elements comprising a set of digits configured to engage mechanically a graspable structure or feature of the item.

### CROSS REFERENCE TO OTHER APPLICATIONS

This application claims priority to U.S. Provisional Patent Application No. 63/746,776 entitled SUCTION AND EDGE GRASPING COMBINATION GRIPPER filed January 17, 2025, which is incorporated herein by reference for all purposes.

### BACKGROUND OF THE INVENTION

Robots may be used to pick/place items, e.g., in logistics settings, such as to pick from a bin, pallet, chute, or conveyor and place in a destination, such as a box or other receptacle for shipping, a pallet, truck or other container, etc.

Robots may include one or more articulate robotic arms each terminating in an “end effector” to be used to grasp items, typically by suction and/or grasping, for example.

In a set or sequence of items to be handled by a robot, some may be graspable using a suction type end effector while others may not. For example, some item materials are leaky (e.g., poly bags), making it difficult to obtain or maintain a grasp by suction. Some items may have exposed flat sides, which may facilitate a grasp using suction, while others may not. For example, in an airport baggage handling context, soft sided and irregularly shaped bags may not be easy or possible to grasp using suction, while hard sided suitcases and boxes may have large, exposed sides that make them very suitable to be grasped using suction.

### BRIEF DESCRIPTION OF THE DRAWINGS

Various embodiments of the invention are disclosed in the following detailed description and the accompanying drawings.

FIG. 1 is a diagram illustrating an embodiment of robotic system comprising a suction and edge grasping combination gripper.

FIGS. 2A and 2B illustrate an embodiment of a suction and edge grasping combination gripper.

FIGS. 3A and 3B illustrate an embodiment of a suction and edge grasping combination gripper.

FIG. 4A is a diagram illustrating an embodiment of a suction and edge grasping combination gripper.

FIGS. 4B and 4C illustrate an embodiment of a suction and edge grasping combination gripper.

FIGS. 5A and 5B illustrate an embodiment of a suction and edge grasping combination gripper.

FIGS. 6A and 6B illustrate an embodiment of a suction and edge grasping combination gripper.

FIGS. 6C and 6D illustrate operation of an embodiment of a suction and edge grasping combination gripper.

FIGS. 7A and 7B illustrate an embodiment of a suction and grasping combination gripper.

FIGS. 8A, 8B, and 8C illustrate an embodiment of a suction and edge grasping combination gripper comprising a bendable digit.

FIGS. 8D and 8E illustrate an embodiment of a suction and edge grasping combination gripper comprising a bendable digit having integrated suction.

FIGS. 8F, 8G, and 8H illustrate alternative arrangements of suction cups and bendable digits.

FIG. 9 is a flow diagram illustrating an embodiment of a process to use a suction and grasping combination gripper in various modes to perform tasks.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A robotic system comprising a suction and edge or other grasping combination gripper is disclosed. In various embodiments, a combination gripper as disclosed herein includes a suction gripper element, e.g., one or more suction pads, surfaces, and/or cups, and a grasping element. In various embodiments, the grasping element may include one or more actuated “graspers” (fingers, hooks, claws, etc., sometimes referred to herein collectively as “digits”), which may be used to grasp a handle, knob, protrusion, or other structure, if present on an item, e.g., instead of and/or in addition to using suction, depending on the item.

In various embodiments, the grasping tool(s) may be small enough to be mounted on edge or edges of the gripper to be used either independently or in conjunction with suction.

In various embodiments, a robotic system as disclosed herein is configured to determine for each item to be grasped a grasp strategy that includes how the combination gripper will be used. For items capable of being grasped using suction, suction only may be used to grasp the item. For items not suitable to be grasped by suction, e.g., suction would be wholly ineffective and/or could damage the item, the graspers only may be used. For items for which suction can be used but may result in a poor seal otherwise insecure grasp, a combination of suction and grasper elements may be used.

Grasper(s) as disclosed herein may be designed to be actuated in any fashion. In some embodiments, compressed air system used for suction is also used to actuate graspers. For minimal weight and complexity, simple off-the-shelf parts may be used for the grasper. If air is used to actuate graspers, the control valves for the grasper may be mounted away from end effector components associated with the suction element. In some embodiments, electrical actuators like solenoids or brushed/brushless motors may be used to actuate graspers as disclosed herein.

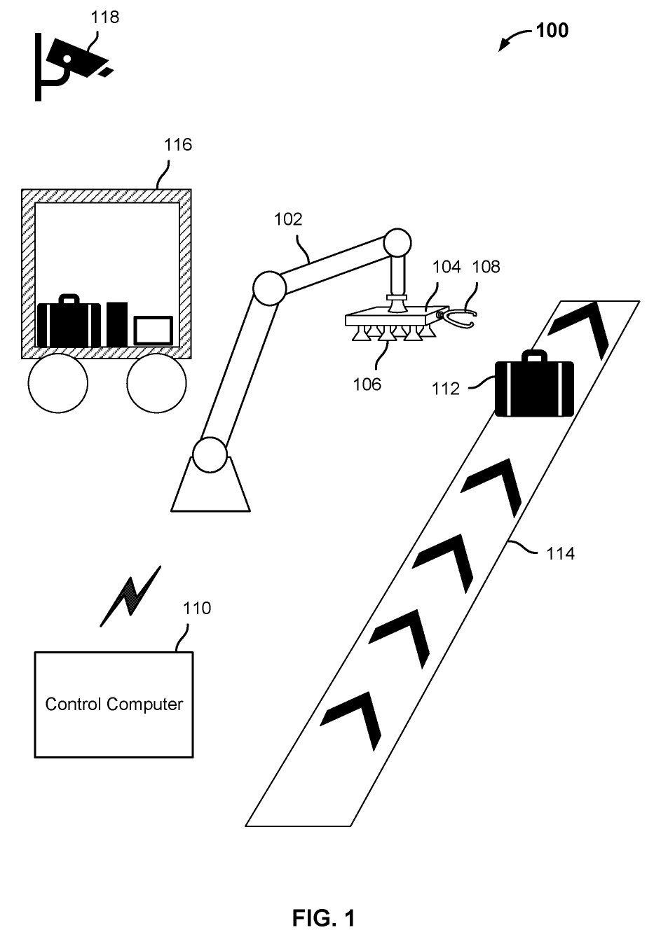

FIG. 1 is a diagram illustrating an embodiment of robotic system comprising a suction and edge grasping combination gripper. In the example shown, robotic system and environment 100 includes a robotic arm 102 having an end effector (comprising body portion 104, suction cups 106, and grasper 108) disposed at a free moving, distal end.

In various embodiments, robotic arm 102 comprises an articulated robotic arm comprising a series of links connected by motor-operated joints. A typical robotic arm may provide six degrees of freedom (6 DOF), although robots have more or fewer degrees of freedom are known. A robotic arm may terminate with a “wrist” joint at its distal, free moving end. The wrist joint may provide three degrees of freedom, e.g., pitch, roll, and yaw, with respect to an end effector mounted at the distal end, such as end effector 104 in the example shown in FIG. 1.

In the example shown, the end effector includes a base portion 104 mounted to the robotic arm 102 at an upper face and a set of suction cups 106 positioned on the lower face, as shown. In addition, a grasper 108 is provided at an edge of the body portion. The robotic arm 102 and end effector 104, 106, 108 are operated under the control of control computer 110. In the example shown, the robotic arm 102 and end effector 104, 106, 108 are positioned to be used to pick items, such as suitcase 112, arriving via conveyor 114 and place each item in a destination container 116. For example, in an airport baggage handling context, the destination container 116 may be a baggage car or cart configured to be towed to an aircraft.

In the example shown, images from camera 118 and/or other sensor data may be received by control computer 110 and used to identify, classify, and/or otherwise determine one or more attributes of an item to be handled, such as suitcase 112. In some embodiments, the conveyor 114 may be robotically controlled, e.g., by computer 110, to position the suitcase 112 and/or other items in a position to be grasped by the robotic arm 102 using its end effector 104, 106, 108.

In various embodiments, a robotic system uses an end effector as disclosed herein in a mode and/or manner determined at least in part based on images or other sensors data, e.g., image data from camera 118. Camera 118 may comprise a three-dimensional camera that produces both 2D image pixels, e.g. RGB pixels, and depth pixels, enabling control computer 110 to generate and maintain a three-dimensional view of at least a portion of the workspace shown in FIG. 1.

In various embodiments, one or more cameras in the workspace and/or mounted on the robot may be used to generate a view of the workspace and items to be picked/placed. The system 100 (e.g., control computer 110) may detect, based on computer vision, the presence of a handle or other protrusion, such as the handle shown on suitcase 112, and a grasp strategy that includes use of grasper 108, as opposed to suction cups 106, may be determined to be includes in a set of feasible grasp strategies considered to be used to pick/place the item. In the example shown in FIG. 1, control computer 110 may determine it would also be feasible to grasp the suitcase 112 using suction cups 106, e.g., along a flat side surface of suitcase 112.

In various embodiments, each feasible grasp strategy is assigned a score, reflecting its relative cost, likelihood of success, etc. and the respective costs are used to select a strategy (and associated combination gripper mode) to be used to grasp the item. The control computer 110 may send commands to the robotic arm 102 and/or end effector 104, 106, 108 to position the operative elements gripper which are to be used to grasp the item, i.e., suction cups 106 and/or grasper 108, to grasp the item.

In various embodiments, a system as disclosed herein learns, e.g., via human supervised or other machine learning, when and/or how it may be advantageous to use the grabber, e.g., alone or in combination with suction. For example, the system may learn to detect when an item may be difficult to grasp with suction alone, e.g., due to its size, dimensions, weight, shape, and/or the nature and/or attributes of its materials (e.g., poly bag versus box, canvas duffle bag versus soft sided suitcase versus hard sided suitcase, etc.).

For example, the system may learn that for certain items, types of items, shapes, features, etc. a given grasp strategy (suction only, grasper only, or both) may be feasible and/or preferred. Over time, for example, the system may learn that items are hard to grasp with suction but have handles, protrusions, and/or other identifiable features suitable to be grasped with a grasper such as grasper 108. For future items having the same or similar features, the system may select or be more likely to select a grasp strategy that includes use of the grasper.

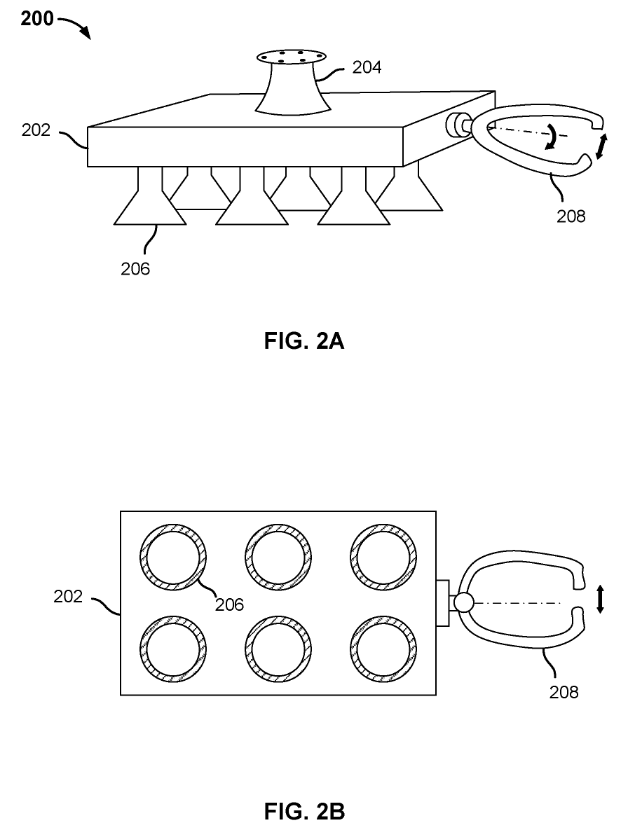

FIGS. 2A and 2B illustrate an embodiment of a suction and edge grasping combination gripper. FIG. 2A shows a perspective view of suction and edge grasping combination gripper 200 and FIG. 2B shows a bottom view of the gripper 200. In the example shown, gripper 200 includes a body 202 coupled mechanically to a mounting structure 204 configured to enable the gripper 200 to be mounted to the distal, operative end of a robotic arm. Gripper 200 further includes a plurality of suction cups (or pads) 206 disposed on the bottom surface of the gripper body 200, in the pose as shown. Gripper 200 further includes a single pinch-grasper 208 at the end of the body 202, to the side of the suction cups 206 as shown.

In the pose as shown, the pinch-grasper 208 is mounted on a side panel of the body 202 and is oriented with a longitudinal or z-axis that is orthogonal to the side on which it is mounted. In the example shown, the pinch-grasper 208 is configured to be rotated around the longitudinal or z-axis, e.g., under robotic control, and to have the pincher elements comprising the pinch-grasper 208 opened or closed under robotic control. In operation, a robotic arm may position the gripper 200 at a location and orientation (pose) that positions the pinch-grasper 208 adjacent to a feature, such as a handle or other graspable structure. The robotic arm may open the pinch-grasper 208, rotate it as/if needed to facilitate insertion, insert one of the pinch elements through an aperture defined by the handle or other structure, and close the pinch-grasper 208 to complete the grasp.

In various embodiments, pinch-grasper 208 is rotated about its longitudinal or z-axis, as/if need, to grasp handles/protrusions at different angles/orientations.

In various embodiments, a grasper such as pinch-grasper 208 may be positioned at long (most distant from the mount 204) end of gripper 200 to improve reach and maneuverability in tight spaces.

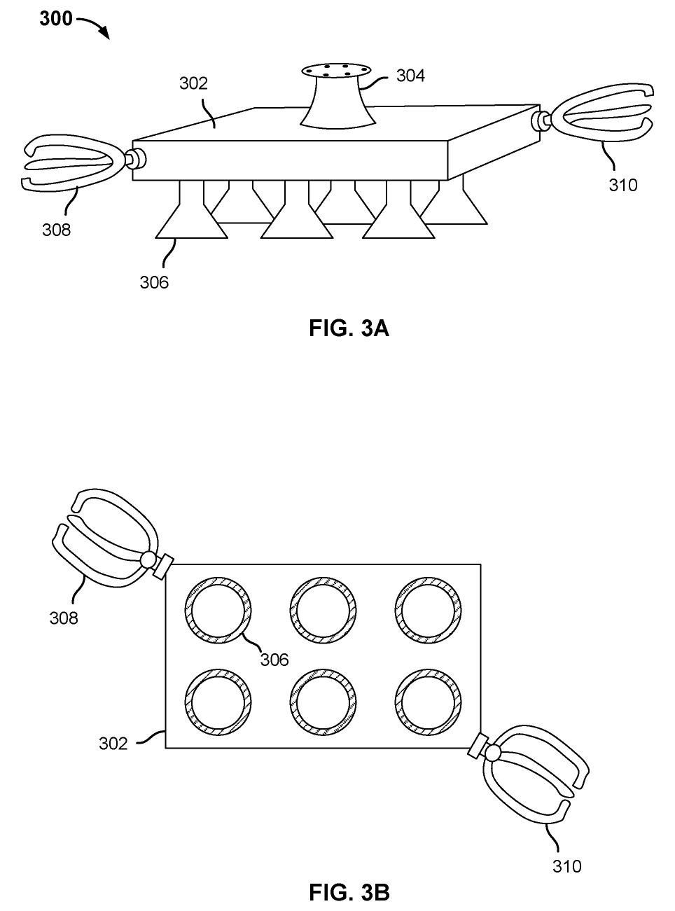

FIGS. 3A and 3B illustrate an embodiment of a suction and edge grasping combination gripper. FIG. 3A shows a perspective view of suction and edge grasping combination gripper 300 and FIG. 3B shows a bottom view of the gripper 300. In the example shown, gripper 300 includes a body 302 coupled mechanically to a mounting structure 304 configured to enable the gripper 300 to be mounted to the distal, operative end of a robotic arm. Gripper 300 further includes a plurality of suction cups (or pads) 306 disposed on the bottom surface of the gripper body 300, in the pose as shown. Gripper 300 further includes dual three-finger (or other digit) graspers 308, 310 at opposite corners of the suction panel 306. In various embodiments, a dual (or more) grasper configuration, as shown, gives robot multiple options for hand position when using the grasper.

While in the example shown in FIGS. 3A and 3B three-fingered graspers 308, 310 are provided, in other embodiments graspers with more or fewer digits may be used. Further, in the examples shown in FIGS. 2A, 2B, 3A, and 3B an array comprising six suction cups 206, 306 is shown, in various embodiments more or fewer suction cups may be included and/or suction pads or other suction or electrostatic type gripping structures may be used.

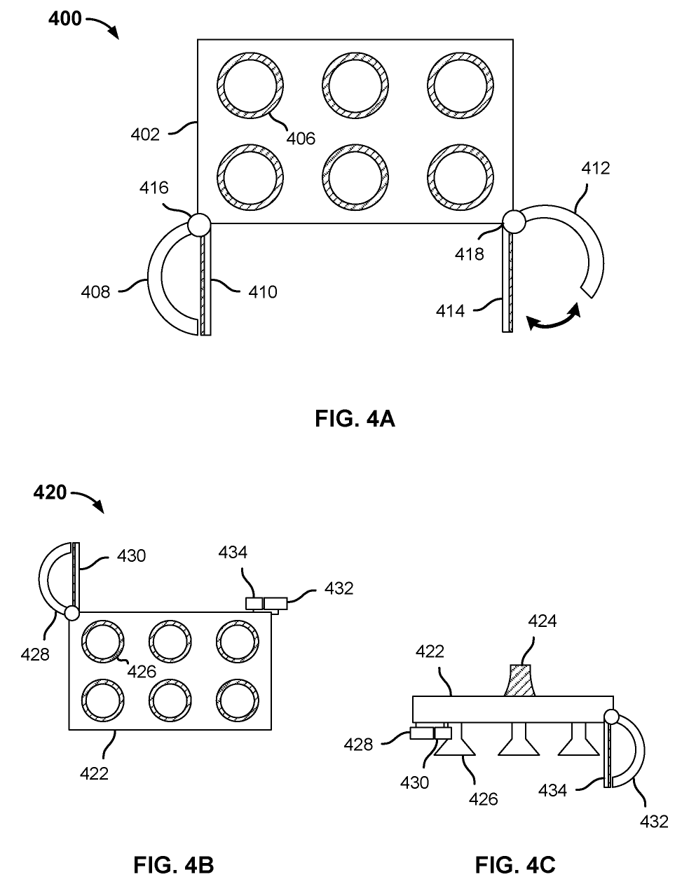

FIG. 4A is a diagram illustrating a bottom view of an embodiment of a suction and edge grasping combination gripper. In the example shown, gripper 400 includes a body 402 on the bottom of which suction cups 406 are disposed. Dual graspers 408, 410 and 412, 414 are disposed on adjacent corners of the body 402, in the same plane as the suction cups 406, in the example shown.

In various embodiments, the graspers 408, 410 and 412, 414 each have one slim finger 410, 414 for sliding under flat handles or similar structures. The curved fingers 408, 412 are configured to rotate about an attachment point (e.g., pin, hinge, etc.) 416, 418 to enable the grasper to be opened/closed.

FIGS. 4B and 4C illustrate an embodiment of a suction and edge grasping combination gripper. FIG. 4B shows a bottom view of gripper 400, while FIG. 4C shows a front side view. In the example shown, gripper 420 includes a body 422, a mounting structure 424, and an array of suction cups 426. In addition, gripper 420 includes a first grasper 428, 430 positioned in the same plane as the suction cups 426 and a second grasper 434, 436 positioned in the adjacent corner of body 422, on the same side of the body 422 as the first grasper 428, 430 and oriented orthogonally to the plane of the suction cups 426.

In various embodiments, graspers may be positioned out-of-plane with each other to provide multiple positioning options for the robot.

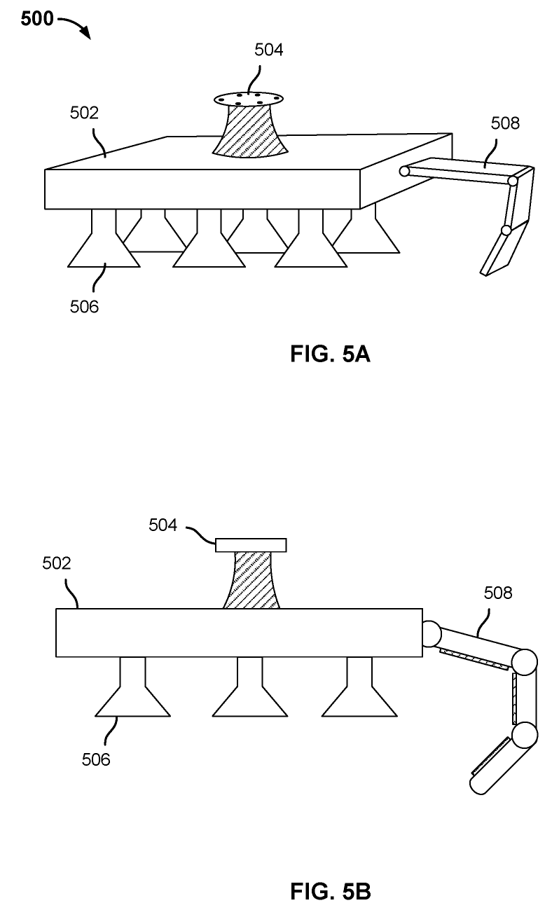

FIGS. 5A and 5B illustrate an embodiment of a suction and edge grasping combination gripper. FIG. 5A shows a perspective view of gripper 500, while FIG. 5B shows a side view. In the example shown, gripper 500 includes a body 502, a mounting structure 504, and an array of suction cups 506. In addition, gripper 500 includes articulated plane grasper 508 at the front of gripper 500 to help support bottom or side of object after being picked by suction cups 506 and/or to engage or partly engage a handle, lip, ledge, or other structure.

In various embodiments, an articulated plane such as articulated plane grasper 508 comprises multiple robotically controlled joints to accommodate varying widths of grasped objects.

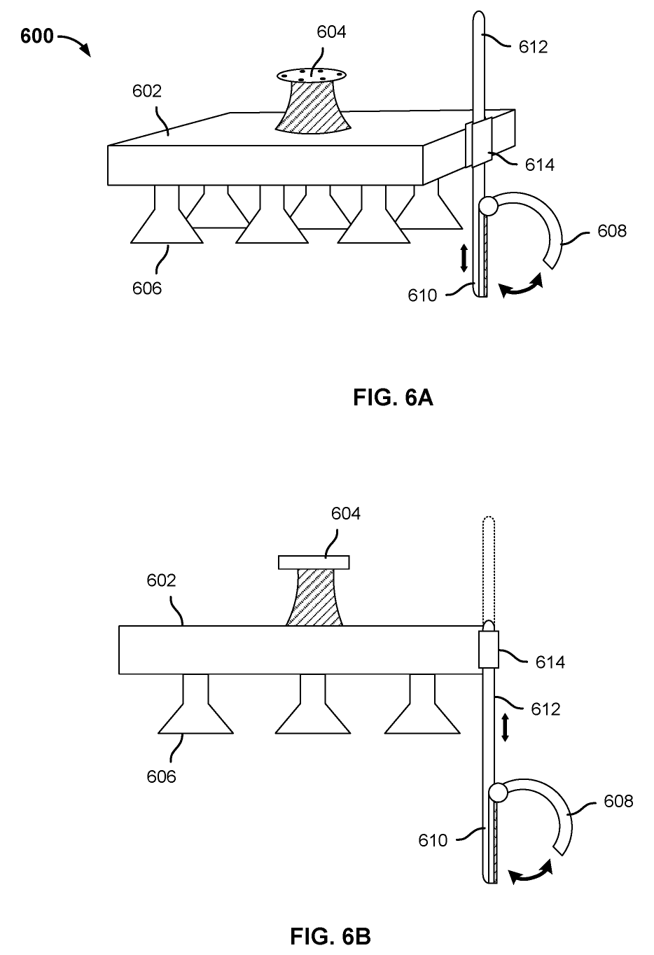

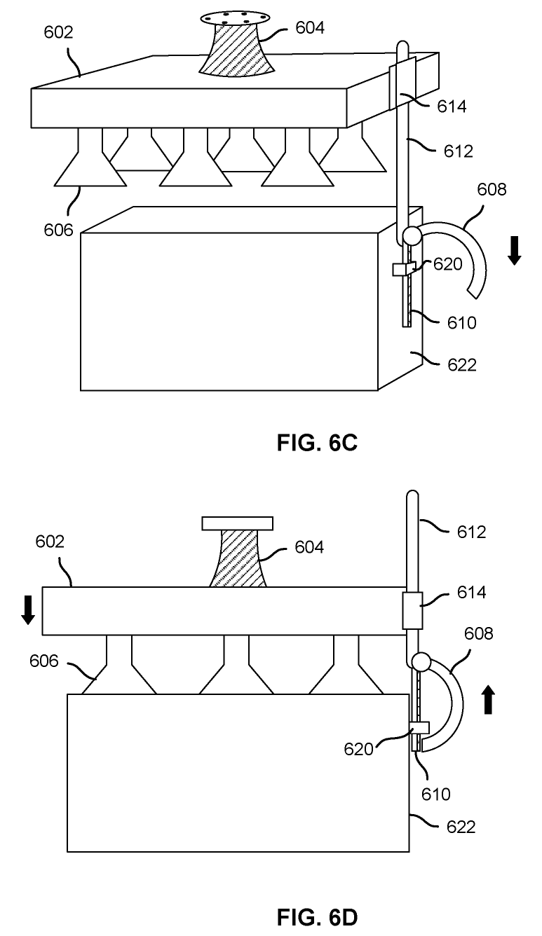

FIGS. 6A and 6B illustrate an embodiment of a suction and edge grasping combination gripper. FIG. 6A shows a perspective view of gripper 600, while FIG. 6B shows a side view. In the example shown, gripper 600 includes a body 602, a mounting structure 604, and an array of suction cups 606. In addition, gripper 600 includes an extendable grabber 608, 610 oriented perpendicular to the plane of the suction cups 606 to extend reach. The grabber 608, 610 is located at the bottom, distal end of shaft or rail 612 which can be moved up or down by operation of linear actuator 614 to extend or retract the grabber 608, 610.

In various embodiments, grabber 608, 610 may be used to grab a protrusion or other feature of or on an item, e.g., to help bring a surface of the item flush with suction cups 606. The grabber 608, 610 may provide additional support to object during motion.

FIGS. 6C and 6D illustrate operation of an embodiment of a suction and edge grasping combination gripper. In the example shown, in FIG. 6C the grabber 608, 610 is fully extended, by operation of linear actuator 614 to insert the straight finger 610 through an opening defined by handle 620 on item 622. FIG. 6D shows the grabber 608, 610 in a closed position, with the grabber 608, 610 having been retracted and the gripper 600 lowered to enable the suction cups 606 to engage a top flat surface of item 622.

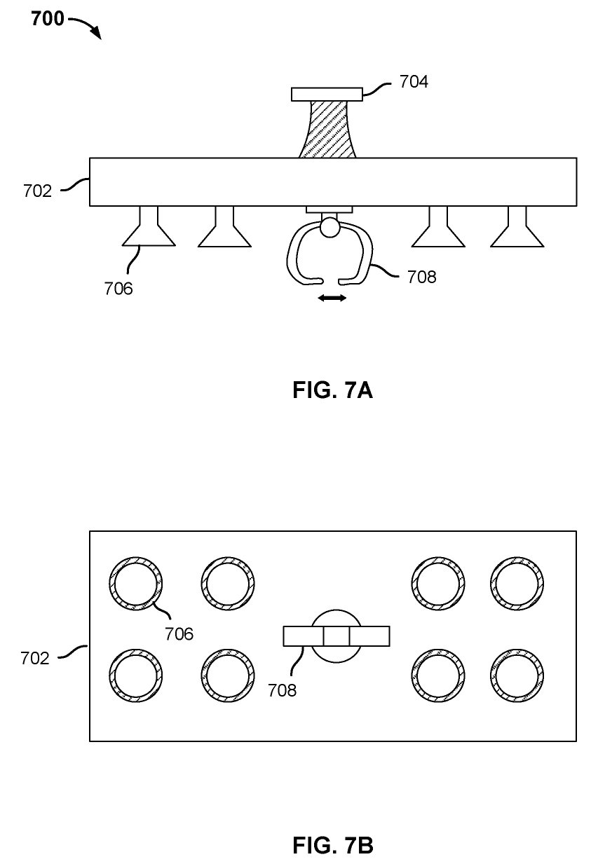

FIGS. 7A and 7B illustrate an embodiment of a suction and grasping combination gripper. FIG. 7A shows a side view of gripper 700, while FIG. 7B shows a bottom view. In the example shown, gripper 700 includes a body 702, a mounting structure 704, and an array of suction cups 706. In addition, gripper 700 includes a grabber 708 disposed in the center of the bottom of gripper 700, e.g., to grasp protrusions. Suction cup 706 panels on either side of grabber 708 may be used to help stabilize an item that has been grasped initially using grabber 708.

In some embodiments, grabber 708 folds flush with suction manifold (e.g., body 702) and/or is flush when fully open, for suction only grasp.

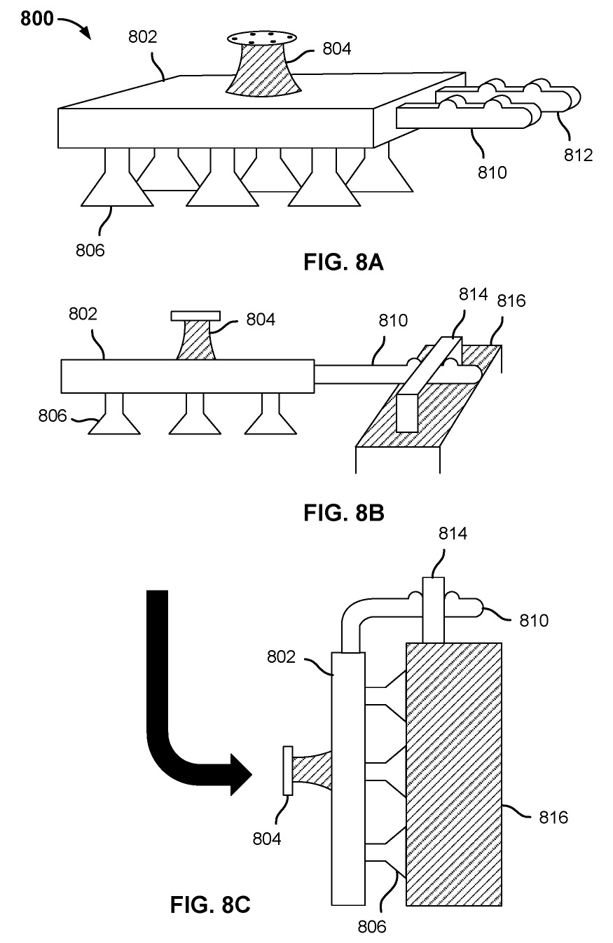

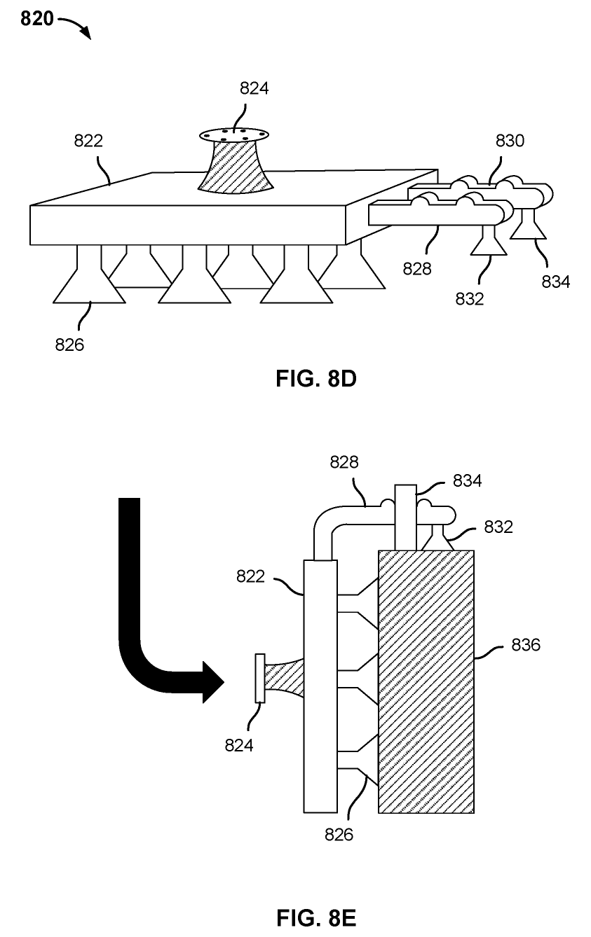

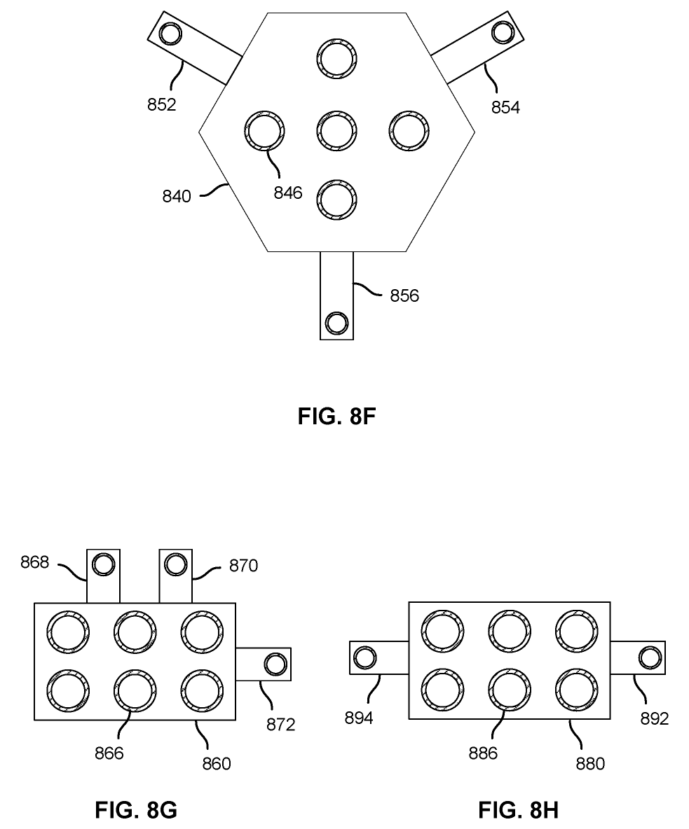

FIGS. 8A, 8B, and 8C illustrate an embodiment of a suction and edge grasping combination gripper comprising one or more bendable digits. FIG. 8A shows a perspective view of gripper 800, FIG. 8B shows a side view of gripper 800 in a first phase of grasping item 816, and FIG. 8C shows a side view of gripper 800 after completing a second phase of grasping an item 816. In the example shown, gripper 800 includes a body 802, mounting structure 804, and an array of suction cups 806. In addition, gripper 800 includes bendable fingers 810, 812 disposed at a front face of the body 802 of gripper 800.

In the example shown, bendable fingers 810, 812 are constructed of a durable but bendable material, e.g., a bendable polymer material. The fingers 810, 812 have bumps on the upper surface, e.g., to engage structures mechanically.

In some embodiments, the bendable fingers 810, 812 are actuated by compressed air. The fingers can grasp exposed handles or protrusions by bending through or around them. For example, in FIG. 8B the fingers 810, 812 of gripper 800 are shown being inserted through an aperture defined by handle 814 of item 816. In the second phase, the robotic arm (not shown) is used to orient the gripper 800 in a vertical pose, as shown in FIG. 8C, enabling suction cups 806 to be used to engage and grasp the flat side surface of item 816, resulting in a secure, dual mode grip.

FIGS. 8D and 8E illustrate an embodiment of a suction and edge grasping combination gripper comprising a bendable digit having integrated suction. FIG. 8D shows a perspective view of gripper 820, while FIG. 8E shows a side view of gripper 820, once a dua mode grasp of item 836 has been completed. In the example shown, gripper 820 includes a body 822, mounting structure 824, and an array of suction cups 826. In addition, gripper 820 includes bendable fingers 828, 830 that are similar to fingers 810, 812 of FIGS. 8A-8C but in addition each has a suction cup 832, 834 at a bottom distal end. As shown in FIG. 8E, in various embodiments the suction cups 832, 834 can be used to ensure the fingers 828, 830 remain in position with respect to the item 836 and handle 832, e.g., as the fingers 828, 830 bend during rotation of the gripper 820 into the position as shown in FIG. 8E and/or as the item 836 is subsequently moved using the robotic arm.

FIGS. 8F, 8G, and 8H illustrate alternative arrangements of suction cups and bendable digits. The gripper shown in FIG. 8F, for example, includes a hexagonal shaped body 840 with an array of five suction cups 846 arranged as shown, with bendable finds 852, 854, 856 extending from every other side of the hexagonally shaped body 840. The gripper shown in FIG. 8G includes a body 860 with suction cups 866, arranged as shown, with bendable fingers 868, 870, and 872 positioned and extending out from body 860 and suction cups 866 as shown. Finally, the gripper shown in FIG. 8H includes a body 880 with suction cups 886, arranged as shown, with bendable fingers 892 and 894 positioned and extending out from body 880 and suction cups 886 as shown.

Many different configurations of suction panel and fingers/graspers are possible.

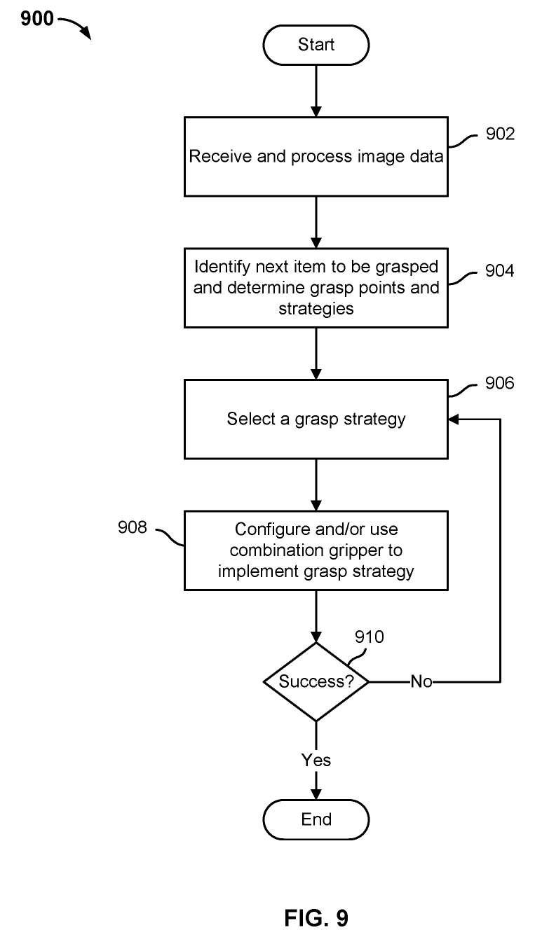

FIG. 9 is a flow diagram illustrating an embodiment of a process to use a suction and grasping combination gripper in various modes to perform tasks. In various embodiments, process 900 may be performed by a control computer, such as control computer 110 of FIG. 1. In the example shown, at 902 image data is received, e.g., from a 3D or other camera in the workspace, such as camera 118 of FIG. 1, and processed to generate a three-dimensional view of at least a portion of the workspace. At 904, a next time to be grasped is identified and grasp locations and strategies to grasp the item are generated. At 906, a preferred grasp strategy is selected. For example, the grasp strategies generated at 904 might each be assigned a score, e.g., reflecting a relative degree of desirability based on cost to achieve, taking into consideration the economy of movement, energy usage, time, etc. and/or likelihood to achieve and maintain the grasp through movement of the item through a trajectory to a destination. At 908, a combination gripper as disclosed herein is configured, as/if needed, and used to implement the strategy selected at 906. For example, a combination gripper as shown in FIGS. 2A through 5B may be moved into an orientation to position a grasper element for use or a suction array for use, depending on the grasp strategy that has been selected.

At 910, a determination is made as to whether the grasp was completed successfully. If so, the robotic arm is used to move the grasped item through its planned trajectory. If not, a new strategy is selected at 906 to grasp the item. In various embodiments, if the item is not grasped successfully after a prescribed number of attempts, a notification is sent to invoke human intervention to assist the system in handling the item.

In various embodiments, a robotic system and/or combination gripper as disclosed herein enables an arbitrary mixed set or sequence of objects, having different materials, size, graspable features, and other varying attributes, to be handled.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a robotic arm;
a combination gripper disposed at a distal, free moving end of the robotic arm, the combination gripper comprising a first set of elements configured to grasp an item by applying suction to a surface of the item and a second set of elements comprising a set of digits configured to engage mechanically a graspable structure or feature of the item; and
a processor coupled to the robotic arm and the combination gripper and configured to determine a strategy to grasp the item using one or both of the first set of elements and the second set of elements, and to implement the grasp strategy by orienting the combination gripper in a pose associated with use of the selected set or sets of elements.

2. The system of claim 1, wherein the second set of elements comprises a grasper element that includes two or more digits.

3. The system of claim 2, wherein the two or more digits include a curved or claw type digit.

4. The system of claim 3, wherein the two or more digits further include a slim, straight digit.

5. The system of claim 4, wherein at least the curved or claw type digit is configured to be operably moved, under robotic control, to open or close the grasper element.

6. The system of claim 2, wherein the combination gripper comprises a substantially cuboid shaped body portion having the first set of elements disposed in an array on a bottom surface of the body portion, the bottom surface comprising a side opposite a top surface of the body portion, the top surface including a mounting structure to mount the combination gripper to the robotic arm.

7. The system of claim 6, where in the grasper element is mounted on a side surface of the body portion.

8. The system of claim 7, wherein the grasper element has a longitudinal axis and the grasper element is mounted with the longitudinal axis substantially parallel to a plane in which the first set of elements are disposed.

9. The system of claim 7, wherein the grasper element has a longitudinal axis and the grasper element is mounted with the longitudinal axis substantially orthogonal to a plane in which the first set of elements are disposed.

10. The system of claim 7, wherein the grasper element is configured to be rotated, under robotic control, about its longitudinal axis.

11. The system of claim 10, wherein the grasper element to pitch, yaw, or both, relative to its longitudinal axis, under robotic control.

12. The system of claim 1, wherein the second set of elements comprises a grasper coupled to an end of a linear member and a linear actuator configured to move the linear member and the grasper coupled thereto up and down relative to a body portion comprising the combination gripper.

13. The system of claim 12, wherein movement of the grasper up and down relative to the body portion enables the grasper to be moved from a first position at or near a plane associated with the first set of elements to a second position extend below and further away from the body portion than the first set of elements.

14. The system of claim 13, wherein the processor is configured to extend the grasper to a position to perform a first grasp of the graspable structure or feature of the item in a first phase of grasping the item; use one or more of the linear actuator, robotic control of orientation of the combination gripper, and the robotic arm to move one or both of the first set of elements and the item into a position in which the first set of elements are positioned to engage the surface of the item; and actuate the first set of elements to grasp the item by applying suction to the surface of the item in a second phase of grasping the item.

15. The system of claim 1, wherein the combination gripper comprises a body portion and the second set of elements includes a plurality of grasper elements, disposed at different locations on the body portion, each grasper elements comprising an associated subset of the digits and each being configured to engage mechanically the graspable structure or feature of the item.

16. The system of claim 15, wherein body portion comprises a cuboid shaped structure and the grasper elements are disposed on opposite sides of the body portion.

17. The system of claim 15, wherein body portion comprises a cuboid shaped structure and the grasper elements are disposed on opposite corners of the body portion.

18. The system of claim 15, wherein a first grasper element included in the plurality of grasper elements is oriented in a plane substantially parallel to a plane associated with the first set of elements and a second grasper element included in the plurality of grasper elements is oriented in a plane substantially orthogonal to said plane associated with the first set of elements and a second

19. The system of claim 1, wherein the combination gripper comprises a substantially cuboid shaped body portion having the first set of elements disposed in an array on a bottom surface of the body portion, the bottom surface comprising a side opposite a top surface of the body portion, the top surface including a mounting structure to mount the combination gripper to the robotic arm and the second set of elements comprises a robotically controlled articulated plane.

20. The system of claim 1, wherein the combination gripper comprises a substantially cuboid shaped body portion having the first set of elements disposed in an array on a bottom surface of the body portion, the bottom surface comprising a side opposite a top surface of the body portion, the top surface including a mounting structure to mount the combination gripper to the robotic arm and the second set of elements comprises a grasper element disposed on the bottom side of the body portion adjacent to at least a subset of the elements comprising the first set of elements.

21. The system of claim 1, wherein the second set of elements includes a bendable finger configured to be inserted through an aperture defined by the graspable structure or feature of the item.

22. The system of claim 21, wherein the processor is configured to using the robotic arm to insert the bendable finger through the aperture defined by the graspable structure or feature of the item; reorient the combination gripper into a position in which the bendable finger is bent and the first set of elements is positioned to engage; the surface of the item; and actuate the first set of elements to grasp the item by applying suction to the surface of the item in a second phase of grasping the item.

23. The system of claim 21, wherein the bendable finger includes one or more suction cups configured to engage via suction at least a portion of the item adjacent to the bendable finger.
